(19) United States
(12) Patent Application Publication
(10) Pub. No.: US 2025/0060979 A1
(43) Pub. Date: Feb. 20, 2025

(54) ANDROID-BASED SYSTEM FOR TOUCH INPUT HANDLING

(71) Applicant: MediaTek Singapore Pte. Ltd., Singapore (SG)

(72) Inventors: Weidong CAO, Beijing (CN); Hongxu ZHAO, Beijing (CN); Qichen ZHANG, Beijing (CN); Zhen JIANG, Beijing (CN); Cunliang DU, Beijing (CN)

(21) Appl. No.: 18/794,229

(22) Filed: Aug. 5, 2024

(30) Foreign Application Priority Data
Aug. 16, 2023 (CN) 202311031584.4
Jun. 28, 2024 (CN) 202410864990.7

(51) Int. Cl. G06F 9/451; G06F 9/52

(52) U.S. Cl. CPC G06F 9/451; G06F 9/52

(57) ABSTRACT

An Android-based system for touch input handling is provided. The system includes an interactive hardware and an application processor. The interactive hardware includes a display panel and a touch panel that runs a touch firmware. The application processor is coupled to the interactive hardware, and runs an application program and a touch driver. The application processor further converts a hardware synchronization signal of the display panel into a software synchronization signal, and generates an application synchronization signal based on the software synchronization signal. Additionally, the application processor further generates an input synchronization signal that is synchronized with the application synchronization signal. The expiration of the input synchronization signal triggers the touch firmware to collect the touch event and propagate the touch event up to the application program through the touch driver.

### CROSS REFERENCE TO RELATED APPLICATIONS

This application claims priority of China Patent Application No. 202311031584.4, filed on Aug. 16, 2023, and China Patent Application No. 202410864990.7, filed on Jun. 28, 2024, the entirety of which is incorporated by reference herein.

### BACKGROUND OF THE INVENTION

### Field of the Invention

The present invention relates to the fields of display technology and communication technology applied in electronic terminal devices, and, in particular, to an android-based system for touch input handling.

### Description of the Related Art

In recent years, touch technology has become popular in electronic terminal equipment, and users have increasingly higher requirements for touch response and standby time of touch terminals.

FIG. 1 is an architecture diagram of a prior-art system 10 for touch input handling. As shown in FIG. 1, system 10 includes an application processor 11 running an application program 112, and an interactive hardware 12 that includes a display panel 120 and a touch panel 121. Generally, the touch panel 121 is used to collect a touch event 150, and propagate the touch event 150 up to the application processor 11. The application processor 11 then generates the output image 195 in response to the touch event 150, for display on the display panel 120.

More details about the conventional process from the user touching the screen to the screen presenting feedback in the system 10 are explained as follows. Upon user touching the screen, the touch firmware 122 ran by the touch panel 121 collects the corresponding touch event 150. Subsequently, this touch event 150 is propagated up to application processor 11. Besides the application program 112, the application processor 11 further runs a touch driver 110, and InputFlinger 111 provided by Android system. The touch driver 110 receives the touch event 150 from the touch firmware 122, and propagates the touch event 150 up to the application program 112 through the InputFlinger 111. Then, the UI thread 113 of the application program 112 draws one or more image layers in response to the touch event 150. Subsequently, these image layers are rendered by the render thread 114 of the application program 112. The rendered image layers are then composed by the SurfaceFlinger thread 115 provided by Android system into the output image 195. Finally, according to the cycle of the hardware synchronization signal (denoted as “HW_Vsync” in figures hereinafter) 160, the output image 195 is presented on the display panel 120, from which the users can see the result of their touch.

FIG. 2 is a timing diagram showing the touch display delay in an earlier Android-based system for touch input handling. Each row in FIG. 2, from top to bottom, shows the durations of touch input handling, UI thread, render thread, SurfaceFlinger thread, and display panel in processing touch events. The blocks labeled “0” represent the current touch event being processed, while the blocks labeled “1” represent the next touch event to be processed, and so on. The term “touch input handling” refers to the touch driver and InputFlinger running on the application processor, receiving and propagating touch events up to the application program. In FIG. 2, T0 is the time when the user touches the screen, and T1 is the time when the display panel responds to the user's touch by presenting corresponding visual feedback, such as pop-up windows or dialog boxes, scrolling interface content, cursor movement, or triggering game character actions. The time interval between T0 and T1 is referred to as “touch display delay,” denoted as “L1” in FIG. 2. Additionally, the time from when touch input handling completes processing the touch event to when the UI thread actually starts drawing image layers in response to the touch event is referred to as “touch response delay,” denoted as “L2” in FIG. 2.

In the early Android-based system shown in FIG. 2, the hardware synchronization signal (HW_Vsync) was used to unify the pacing of drawing, rendering, composition, and display. However, the touch display delay of the entire pipeline was relatively large. The touch display delay is the key factor affecting the smoothness of user operation. Therefore, reducing the touch display delay L1 can significantly improve the user experience. Based on this motivation, the system 10 shown in FIG. 1 incorporates the mechanism of the application synchronization signal and the SurfaceFlinger synchronization signal. As shown in FIG. 1, the UI thread 113 and SurfaceFlinger thread 115 are executed according to the cycle of an application synchronization signal (denoted as “Vsync_APP” in figures hereinafter) 180 and a SurfaceFlinger synchronization signal (denoted as “Vsync_SF” in figures hereinafter) 190, respectively. Specifically, the expiration of the application synchronization signal 180 triggers the UI thread 113 to draw the image layers in response to the touch event 150, and the expiration of the SurfaceFlinger synchronization signal 190 triggers the SurfaceFlinger thread 115 to compose the image layers rendered by the render thread 114 into the output image 195 for display on the display panel 120. Additionally, both the application synchronization signal 180 and the SurfaceFlinger synchronization signal 190 are generated based on a software synchronization signal (denoted as “SW_Vsync” in figures hereinafter) 170, and the software synchronization signal 170 is converted from the hardware synchronization signal 160. The generation of the application synchronization signal 180 and the SurfaceFlinger synchronization signal 190 will be further explained with reference to FIG. 3 in the next paragraph.

FIG. 3 is a schematic diagram illustrating the generation of the application synchronization signal and the SurfaceFlinger synchronization signal. As shown in FIG. 3, the hardware synchronization signal 160 is converted into the software synchronization signal 170. Then application shift 301 and SurfaceFlinger shift 302 are incorporated with the software synchronization signal 170 to generate the application synchronization signal 180 and the SurfaceFlinger synchronization signal 190, respectively. Application shift 301 refers to the time deviation between the start times of the UI thread and the hardware synchronization signal. SurfaceFlinger shift 302 refers to time deviation between the start times of the SurfaceFlinger thread and the hardware synchronization signal. These shifts are designed to make the overall pipeline processing more efficient and to improve system performance.

FIG. 4 is a timing diagram showing the touch display delay in the prior-art system 10. As shown in FIG. 4, the UI thread and rendering thread of the application program start drawing and rendering in response to each touch event according to the application synchronization signal (Vsync_App), the SurfaceFlinger thread starts composing the image layers according to the SurfaceFlinger synchronization signal (Vsync_SF), and the display panel refreshes and displays the output image according to the hardware synchronization signal (HW_Vsync). In this way, for each touch event, the drawing is completed and followed by timely rendering and composing, resulting in visual feedback being presented on the display panel within a shorter period of time. As shown in FIG. 4, T0′ is the time when the user touches the screen, and T1′ is the time when the display panel responds to the user's touch by presenting the corresponding visual feedback. The time interval between T0′ and T1′, which is the touch display delay L1′, is much smaller than the touch display delay L1 in FIG. 2.

In a prior-art implementation, in order to extend the standby time of the touch terminal and reduce system power consumption, system 10 further involves adaptive refresh technology to adjust the frequency of hardware synchronization signals based on the display content. Refer to FIG. 5, which is a timing diagram of a touch display system involving adaptive refresh technology. As shown in FIG. 5, the shaded area 500 indicates that when the display content is static or changes slightly, the system reduces the display refresh rate, that is, the frequency of the hardware synchronization signal (HW_Vsync) decreases. When the display content changes dynamically, the refresh rate returns to a higher rate. In this way, the standby time of the touch terminal is extended and power consumption is reduced.

In order to instantly capture user touch actions and further optimize the touch response delay L2, many terminal touch panels use a high sampling frequency, meaning that the maximum sampling frequency of the touch panel is several times the refresh rate of the display panel. Refer to FIG. 6, which is a timing diagram of a touch display system operating with a high sampling frequency of the touch panel. As shown in FIG. 6, within one cycle of the hardware synchronization signal (HW_Vsync), the number of touch events collected and propagated by the high-frequency touch panel (3 in this example) is much greater than the number of touch events collected and propagated by the low-frequency touch panel (1 in this example). The touch response delay for the low-frequency touch panel is denoted as L2, while the touch response delay for the high-frequency touch panel is denoted as L2′. Obviously, L2′ is much shorter than L2, indicating that the touch response delay is much lower for high-frequency touch panels. However, propagating touch events up to the application processor at a high sampling frequency significantly increases power consumption.

In another prior-art implementation, to solve the high power consumption problem of the high-frequency touch panel, system 10 further monitors the hardware synchronization signal to determine the appropriate timing for propagating touch events. Refer to FIG. 7, which is a timing diagram of a touch display system that monitors the hardware synchronization signal to determine the timing for propagating touch events. As shown in FIG. 7, the timing for touch input handling (including the touch driver and InputFlinger receiving and propagating the touch event) is scheduled immediately before the expiration of the hardware synchronization signal (HW_Vsync). In this way, the system does not need to propagate touch events up to the application processor at a high frequency, thereby saving power consumption. However, the phase difference between the hardware synchronization signal (HW_Vsync) and the application synchronization signal (Vsync_APP) still results in a delay from when the UI thread processes the touch event to when the touch event propagation is completed, as indicated by the touch response delay L2″ in FIG. 7.

In addition to the issue of touch response delay, the above-described system that adopts the hardware synchronization signal monitoring mechanism may encounter additional problems when using adaptive refresh technology. Specifically, when the frequency of the application synchronization signal (Vsync_APP) is higher than that of the hardware synchronization signal (HW_Vsync), if an application synchronization signal (Vsync_APP) expires without a corresponding hardware synchronization signal (HW_Vsync) being generated in that frame, the UI thread triggered by the application synchronization signal (Vsync_APP) will have no corresponding touch event to process. Refer to FIG. 8, which is a timing diagram of a touch display system that adopts both adaptive refresh technology and the hardware synchronization signal monitoring mechanism. As shown in FIG. 8, due to the absence of a touch event propagated up to the application program within the cycle of the application synchronization signal (Vsync_APP) indicated by block 800, the UI thread during the period indicated by block 801 has no corresponding touch event to process. This results in some touch events, such as the touch event labeled “2” in FIG. 8, possibly being missed, and failing to present the corresponding visual feedback to the user on the display panel.

Therefore, a system for touch input handling is needed to solve the aforementioned issues.

### BRIEF SUMMARY OF THE INVENTION

An embodiment of the present invention provides Android-based system for touch input handling. The system includes an interactive hardware and an application processor. The interactive hardware includes a display panel and a touch panel that runs a touch firmware. The application processor is coupled to the interactive hardware, and is running an application program and a touch driver. The application processor further converts the hardware synchronization signal of the display panel into a software synchronization signal, and generates an application synchronization signal based on the software synchronization signal. The expiration of the application synchronization signal triggers the UI thread of the application program to draw one or more image layers in response to the touch event collected by the touch panel. Additionally, the application processor further generates an input synchronization signal that is synchronized with the application synchronization signal. The expiration of the input synchronization signal triggers the touch firmware to collect the touch event and propagate the touch event up to the application program through the touch driver.

In an embodiment, the touch firmware includes a touch collection thread, a touch processing thread, and a control module. The touch collection thread is configured to collect a batch of touch events within one cycle of the application synchronization signal. The touch processing thread is configured to process the touch events collected by the touch collection thread and store the processed touch events into a touch event buffer. The control module is configured to handle the batch of touch events. The handling of the batch of touch events is triggered by the expiration of the input synchronization signal, and includes triggering the touch collection thread and the touch processing thread to collect, process, and store an immediate touch event, and propagating up the batch of touch events, including the immediate touch event, from the touch event buffer to the touch driver.

In an embodiment, the application processor generates the input synchronization signal by obtaining expiration time of the application synchronization signal through a system call and setting the expiration time of the application synchronization signal as a base time, predicting a phase time based on system scheduling information, setting the generation time of the input synchronization signal as the sum of the base time and the phase time, and using the generation time of the input synchronization signal to start a timer. The phase time refers to time required for the touch driver and InputFlinger to propagate the touch event up to the application program. The timer is configured to notify the touch driver to propagate the touch event up to the application program through the InputFlinger, upon the expiration of the input synchronization signal.

In an embodiment, the application processor predicts the phase time by using a machine learning-based algorithm and a debounce algorithm.

In an embodiment, the application processor is directly connected to the touch panel.

In an embodiment, the application processor further runs a software timer and an interrupt service routine, and starts the software timer according to the input synchronization signal. The software timer is configured to notify the touch firmware through the interrupt service routine to collect the touch event and propagate the touch event up to the touch driver, upon the expiration of the input synchronization signal. The software timer is further configured to notify the touch driver through the interrupt service routine to propagate the touch event up to the application program, upon the expiration of the input synchronization signal.

In an embodiment, the application processor further includes a hardware timer and an interrupt controller, and starts the hardware timer according to the input synchronization signal. The hardware timer is configured to notify the touch firmware to collect the touch event and propagate the touch event up to the touch driver, upon the expiration of the input synchronization signal. The hardware timer is further configured to notify the touch driver through the interrupt controller to propagate the touch event up to the application program, upon the expiration of the input synchronization signal.

In an embodiment, the system further includes a microprocessor and a shared memory. The microprocessor is directly connected to the touch panel and the application processor, includes a first interrupt controller, and runs a secondary touch driver. The expiration of the input synchronization signal triggers the first interrupt controller to send an interrupt request signal to the secondary touch driver. The shared memory is accessible by both the microprocessor and the application processor. The application processor further includes a second interrupt controller. The secondary touch driver is configured to handle the touch event upon receiving the interrupt request signal. The handling of the touch event includes receiving the touch event propagated from the touch firmware, storing the touch event into the shared memory, and notifying the touch driver through the second interrupt controller to read the touch event from the shared memory.

In an embodiment, the microprocessor further includes a hardware timer, and starts the hardware timer according to the input synchronization signal. The hardware timer is configured to notify the secondary touch driver through the first interrupt controller to handle the touch event, upon the expiration of the input synchronization signal. In a further embodiment, the secondary touch driver is further configured to notify the touch firmware to collect the touch event and propagate the touch event up to the secondary touch driver, upon receiving the interrupt request signal. In another further embodiment, the hardware timer is directly connected to the touch panel, and is further configured to notify the touch firmware to collect the touch event and propagate the touch event up to the secondary touch driver, upon the expiration of the input synchronization signal.

In an embodiment, the application processor further includes a hardware timer that is directly connected to the first interrupt controller, and starts the hardware timer according to the input synchronization signal. The hardware timer is configured to notify the secondary touch driver through the first interrupt controller to handle the touch event, upon the expiration of the input synchronization signal. In a further embodiment, the secondary touch driver is further configured to notify the touch firmware to collect the touch event and propagate the touch event up to the secondary touch driver, upon receiving the interrupt request signal. In another further embodiment, the hardware timer is directly connected to the touch panel, and is further configured to notify the touch firmware to collect the touch event and propagate the touch event up to the secondary touch driver, upon the expiration of the input synchronization signal.

In an embodiment, the application processor further generates a SurfaceFlinger synchronization signal based on the software synchronization signal. A render thread of the application program is configured to render the image layers drawn by the UI thread. The application processor further runs a SurfaceFlinger thread that is triggered by the expiration of the SurfaceFlinger synchronization signal to compose the image layers rendered by the render thread into an output image for display on the display panel.

The Android-based system for touch input handling provided by the embodiments of the present disclosure can satisfy user requirements for touch response and standby time of touch terminals while maintaining both high sampling rates and low power consumption.

### BRIEF DESCRIPTION OF THE DRAWINGS

The present invention can be more fully understood by reading the subsequent detailed description and examples with references made to the accompanying drawings, wherein:

FIG. 1 is an architecture diagram of a prior-art system;

FIG. 2 is a timing diagram showing the touch display delay in an earlier Android-based system for touch input handling;

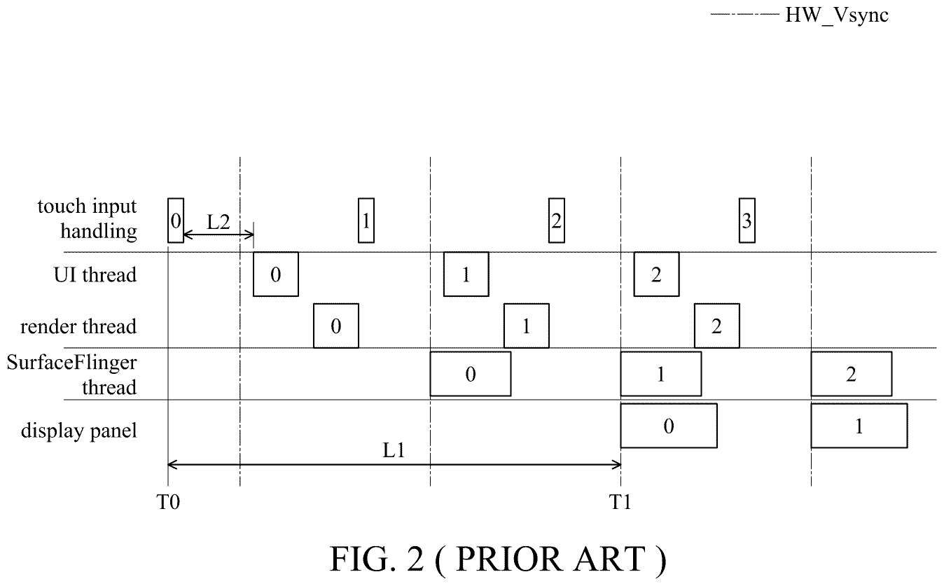

FIG. 3 is a schematic diagram illustrating the generation of the application synchronization signal and the SurfaceFlinger synchronization signal;

FIG. 4 is a timing diagram showing the touch display delay in the prior-art system;

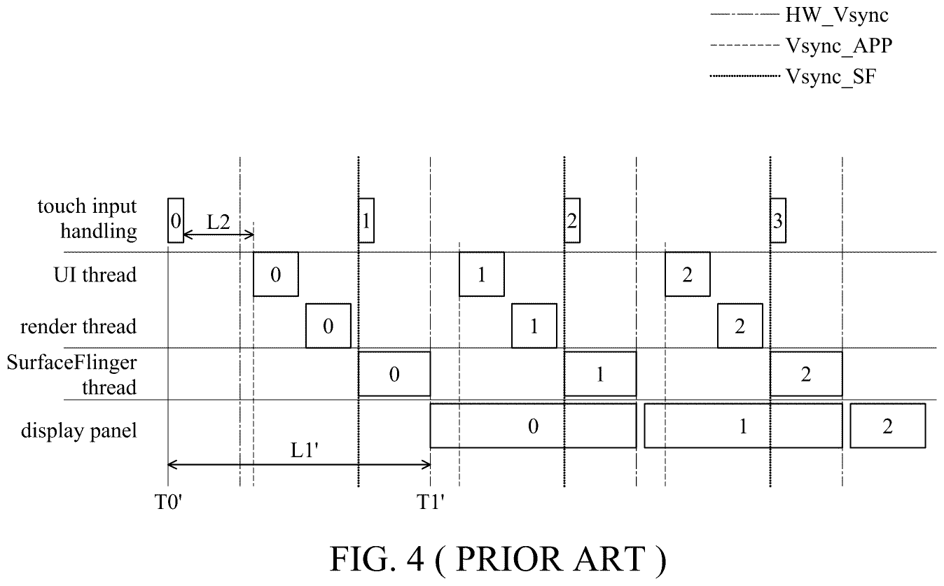

FIG. 5 is a timing diagram of the a display system involving adaptive refresh technology;

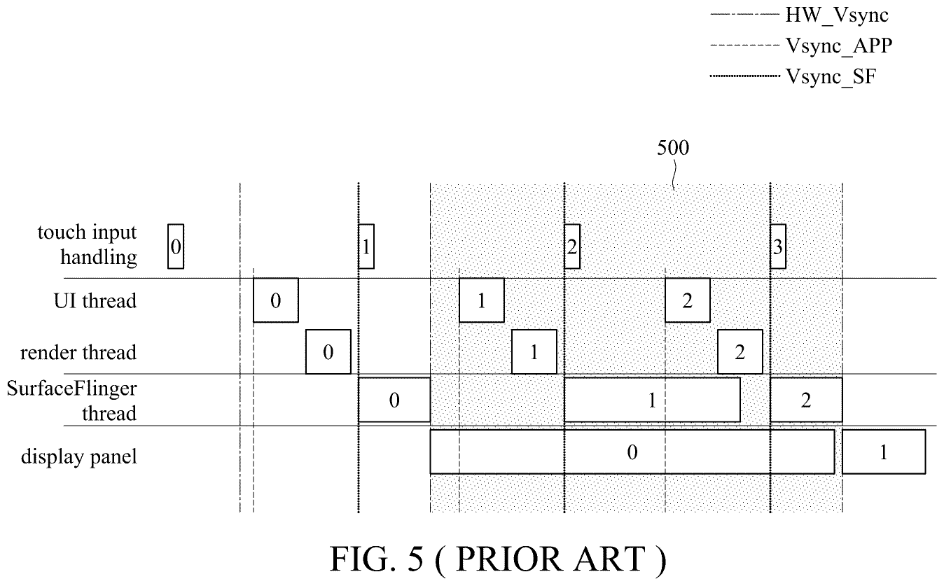

FIG. 6 is a timing diagram of a touch display system operating with a high sampling frequency of the touch panel;

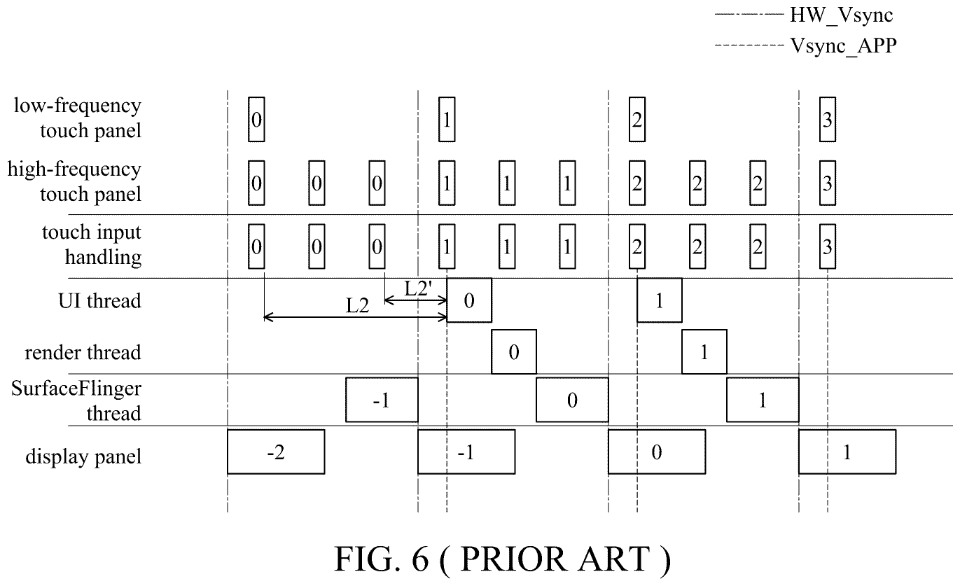

FIG. 7 is a timing diagram of a touch display system that monitors the hardware synchronization signal to determine the timing for propagating touch events;

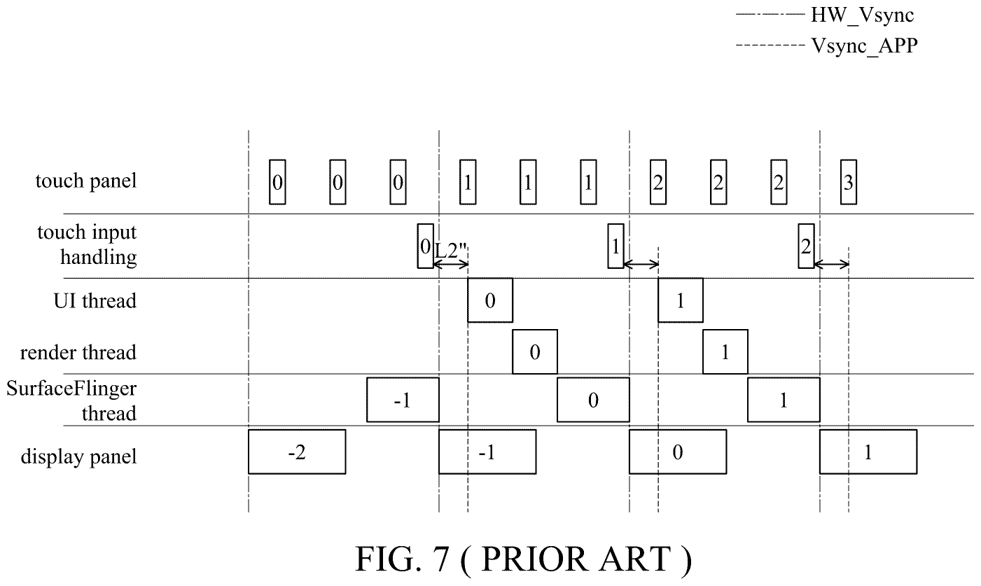

FIG. 8 is a timing diagram of a touch display system that adopts both adaptive refresh technology and the hardware synchronization signal monitoring mechanism;

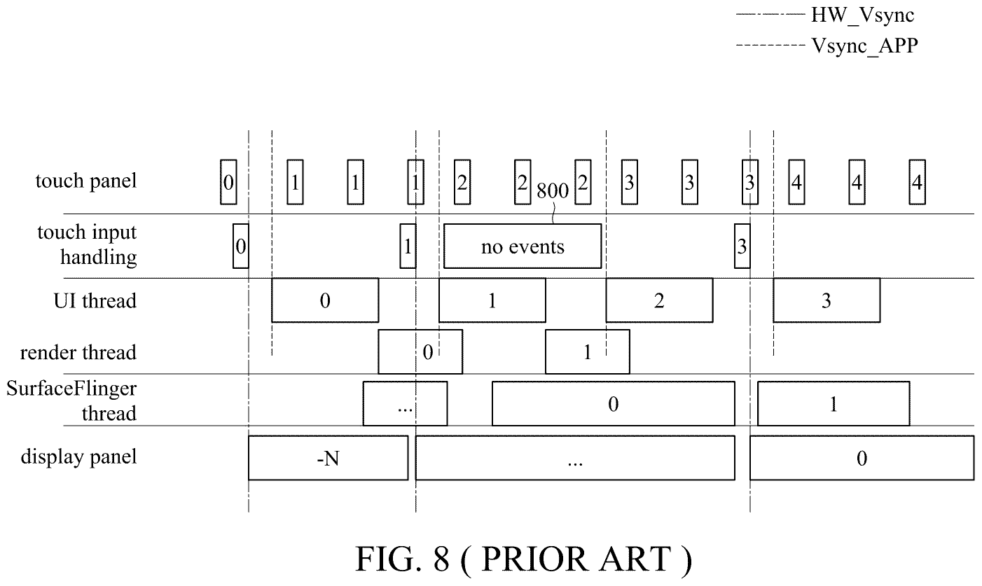

FIG. 9 is an architecture diagram of an Android-based system for touch input handling, according to an embodiment of the present disclosure;

FIG. 10 is a timing diagram of an Android-based system for touch input handling, according to an embodiment of the present disclosure;

FIG. 11 is a timing diagram of an Android-based system for touch input handling that adopts the batch propagation mechanism, according to a further embodiment;

FIG. 12 is an architecture diagram of the touch firmware implementing the batch propagation mechanism, according to an embodiment of the present disclosure;

FIG. 13 is a timing diagram of touch event handling in the touch firmware, according to an embodiment of the present disclosure;

FIG. 14 is a flow diagram illustrating the generation process of the input synchronization signal, according to an embodiment of the present disclosure;

FIG. 15 illustrates the first embodiment of the input synchronization signal expiration notification mechanism adopted in the system for touch input handling;

FIG. 16 illustrates the second embodiment of the input synchronization signal expiration notification mechanism adopted in the system for touch input handling;

FIG. 17 illustrates the third embodiment of the system for touch input handling, in which a microprocessor is included in the system to facilitate the propagation of the touch event;

FIG. 18 illustrates the first implementation of the third embodiment of the system for touch input handling, in which the microprocessor is included in the system to facilitate the propagation of the touch event;

FIG. 19 illustrates the second implementation of the third embodiment of the system for touch input handling, in which the microprocessor is included in the system to facilitate the propagation of the touch event;

FIG. 20 illustrates the third implementation of the third embodiment of the system for touch input handling, in which the microprocessor is included in the system to facilitate the propagation of the touch event;

FIG. 21 illustrates the fourth implementation of the third embodiment of the system for touch input handling, in which the microprocessor is included in the system to facilitate the propagation of the touch event;

### DETAILED DESCRIPTION OF THE INVENTION

The following description is made for the purpose of illustrating the general principles of the invention and should not be taken in a limiting sense. The scope of the invention is best determined by reference to the appended claims.

In the specification and claims, certain terms are used to refer to specific elements. It should be appreciated by those skilled in the art that hardware manufacturers may use different terminology to refer to the same element. This specification and claims do not differentiate elements based on terminology differences, but rather based on functional differences. The term “comprising” as used throughout the specification and claims is intended to be an open-ended term, meaning “including but not limited to.” Furthermore, the term “coupled” encompasses any direct or indirect electrical connection means. Therefore, if the specification describes that a first device is coupled to a second device, it means that the first device can be electrically connected directly to the second device, or indirectly connected through other devices or connection means.

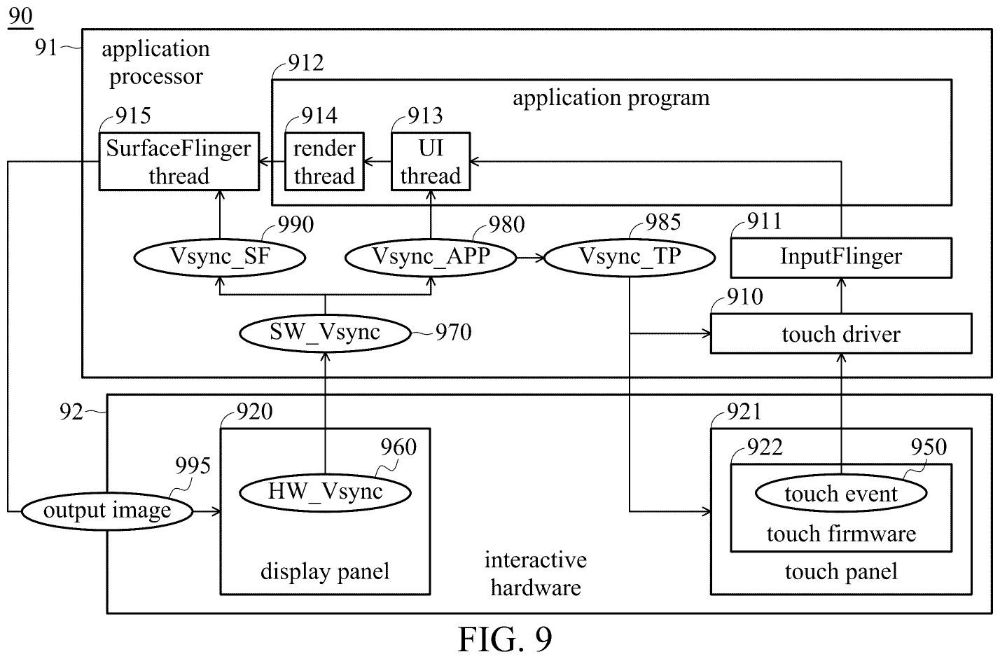

FIG. 9 is an architecture diagram of an Android-based system 90 for touch input handling, according to an embodiment of the present disclosure. As shown in FIG. 9, system 90 includes an application processor 91 running an application program 912, and an interactive hardware 92 that includes a display panel 920 and a touch panel 921. The application processor 91 and the interactive hardware 92 are coupled to and communicable with each other. Generally, the touch panel 921 is used to collect a touch event 950, and propagate the touch event 950 up to the application processor 91. The application processor 91 then generates the output image 995 in response to the touch event 950, for display on the display panel 920.

More details about the process from the user touching the screen to the screen presenting feedback in the system 90 are explained as follows. Upon user touching the screen, the touch firmware 922 ran by the touch panel 921 collects the corresponding touch event 950. The touch event 950 may involve touch position (i.e., the coordinates of the touch point on the screen), touch pressure (i.e., the amount of pressure applied to the screen), touch size (i.e., the size of the touch area), touch time (i.e., the timestamp of when the touch event occurred), and/or other related information that help the system accurately interpret and respond to user interactions. Subsequently, the touch event 950 is propagated up to application processor 91. Besides the application program 912, the application processor 91 further runs a touch driver 910, and InputFlinger 911 provided by Android system. The touch driver 910 receives the touch event 950 from the touch firmware 922, and propagates the touch event 950 up to the application program 912 through the InputFlinger 911. Then, the UI thread 913 of the application program 912 draws one or more image layers in response to the touch event 950. Subsequently, these image layers are rendered by the render thread 914 of the application program 912. The rendered image layers are then composed by the SurfaceFlinger thread 915 provided by Android system into the output image 995. Finally, according to the cycle of the hardware synchronization signal 960, the output image 995 is presented on the display panel 920, from which the users can see the result of their touch.

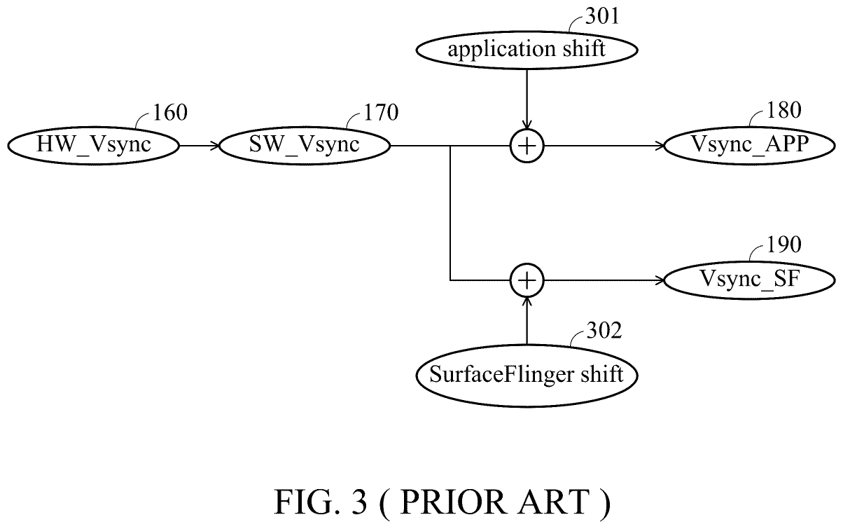

In addition, the UI thread 913 and SurfaceFlinger thread 915 are executed according to the cycle of an application synchronization signal 980 and a SurfaceFlinger synchronization signal 990, respectively. Specifically, the expiration of the application synchronization signal 980 triggers the UI thread 913 to draw the image layers in response to the touch event 950, and the expiration of the SurfaceFlinger synchronization signal 990 triggers the SurfaceFlinger thread 915 to compose the image layers rendered by the render thread 914 into the output image 995 for display on the display panel 920. Additionally, both the application synchronization signal 980 and the SurfaceFlinger synchronization signal 990 are generated based on a software synchronization signal (denoted as “SW_Vsync” in figures hereinafter) 970, and the software synchronization signal 970 is converted from the hardware synchronization signal 960. The process by which the application processor 91 generates the application synchronization signal 980 and the SurfaceFlinger synchronization signal 990 is as previously illustrated in FIG. 3 and will not be reiterated herein.

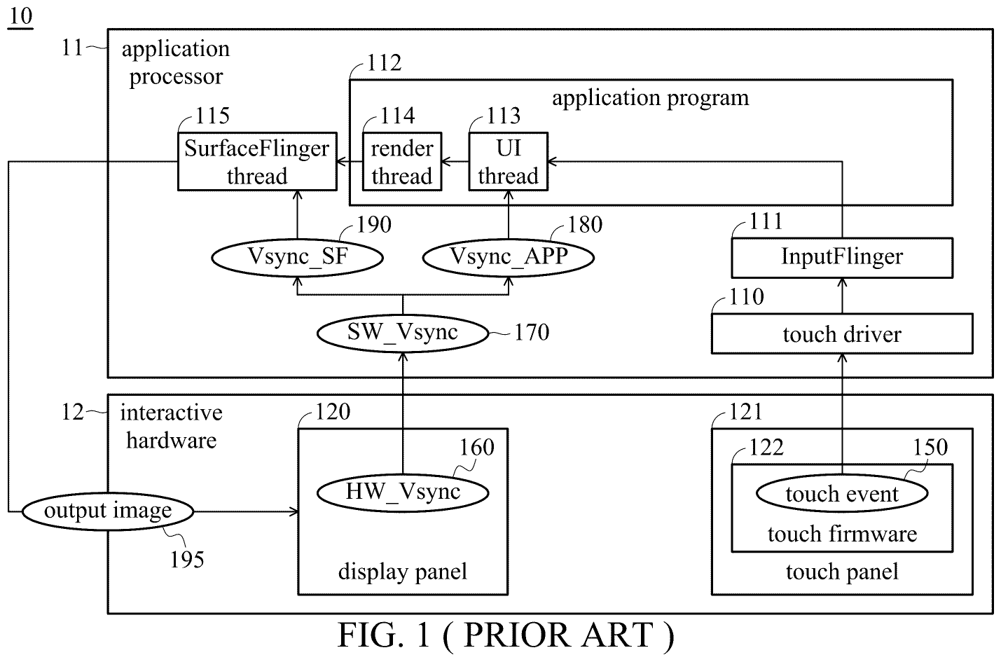

Compared to the prior-art system 10 illustrated in FIG. 1, system 90 further incorporates the use of input synchronization signal (denoted as “Vsync_TP” in figures hereinafter) 985 to control the timing of the propagation of the touch event 950. Specifically, besides the application synchronization signal 980 and the SurfaceFlinger synchronization signal 990, the application processor 91 further generates the input synchronization signal 985 that is synchronized with the application synchronization signal 980, and the expiration of the input synchronization signal 985 triggers the touch firmware 922 to collect the touch event 950 and propagate the touch event 950 up to the application program 912 through the touch driver 910.

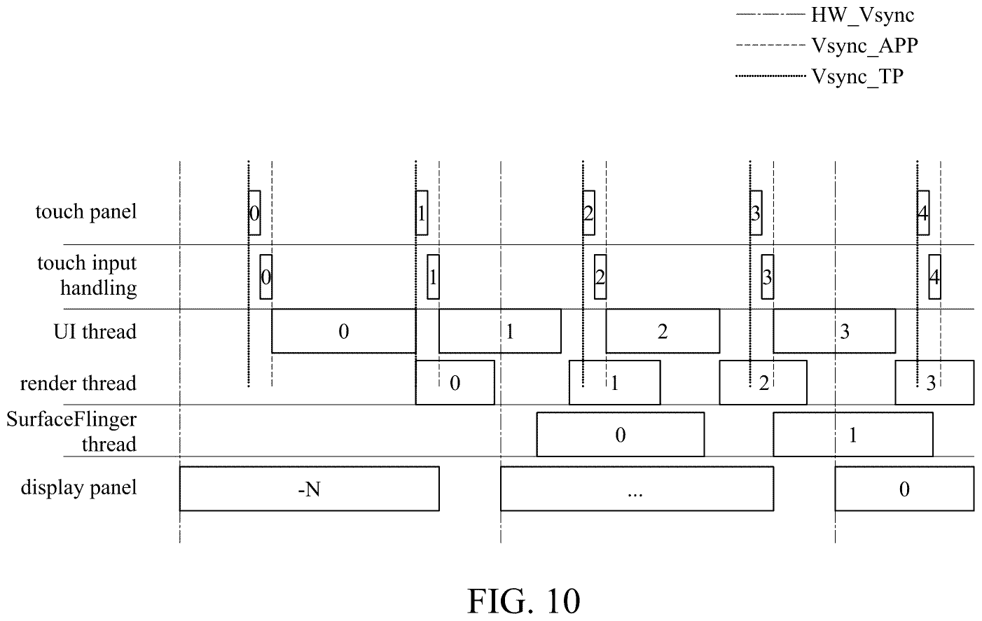

FIG. 10 is a timing diagram of an Android-based system for touch input handling, according to an embodiment of the present disclosure. In this embodiment, the input synchronization signal (Vsync_TP) is synchronized with the application synchronization signal (Vsync_APP). In other words, each cycle of the input synchronization signal (Vsync_TP) is dependent on the application synchronization signal (Vsync_APP). For example, when the refresh rate of the display panel is 120 Hertz, the cycle of the application synchronization signal (Vsync_APP) is approximately 8.3 milliseconds, and the cycle of the input synchronization signal (Vsync_TP) is also approximately 8.3 milliseconds. In this way, the cycle of the input synchronization signal (Vsync_TP) always starts a certain phase difference before the application synchronization signal (Vsync_APP). As shown in FIG. 10, this phase difference is set to be approximately equal to the time required for touch input handling to process a touch event (including the touch driver and InputFlinger receiving and propagating the touch event). As a result, there is almost no touch response delay from when the UI thread processes the touch event to when the touch event is propagated, creating a smoother user touch experience.

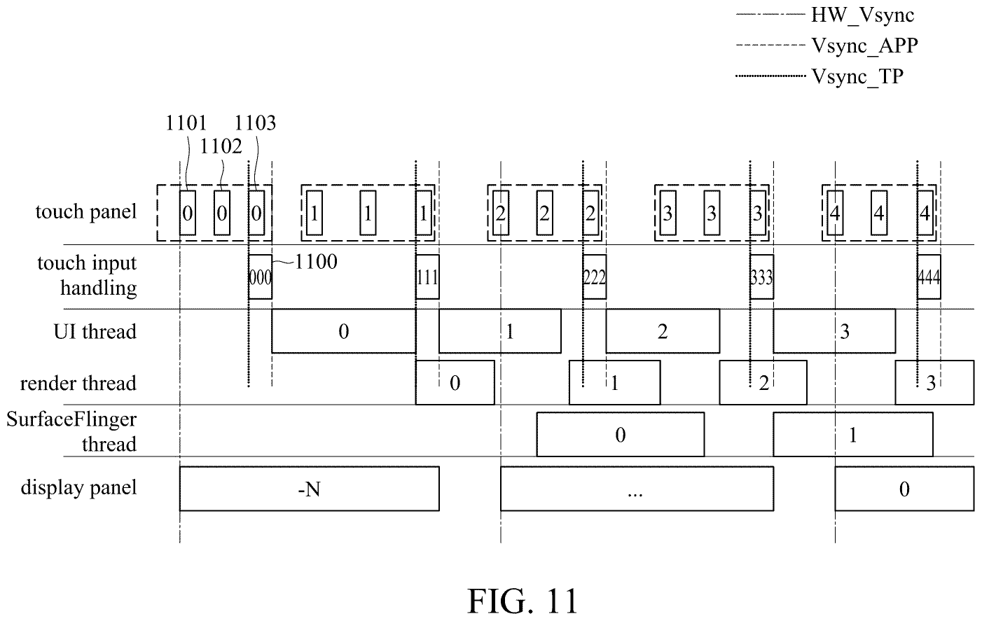

As previously discussed, many terminal touch panels use a high sampling frequency. This may result in several touch events being collected by the touch panel within one cycle of the application synchronization signal (Vsync_APP). To address this situation without increasing the frequency of touch events propagation (for power-saving considerations), a further embodiment of the present disclosure adopts a batch propagation mechanism. Refer to FIG. 11, which is a timing diagram of an Android-based system for touch input handling that adopts the batch propagation mechanism, according to this embodiment. As shown in FIG. 11, touch input handling propagates a batch of touch events 1100 within one cycle of the application synchronization signal (Vsync_APP). This batch of touch events 1100 includes touch events 1101 and 1102 collected before the input synchronization signal expiration, as well as the immediate touch event 1103 collected upon input synchronization signal expiration. Subsequently, the UI thread will draw the corresponding one or more image layers based on the contents of touch events 1101-1103.

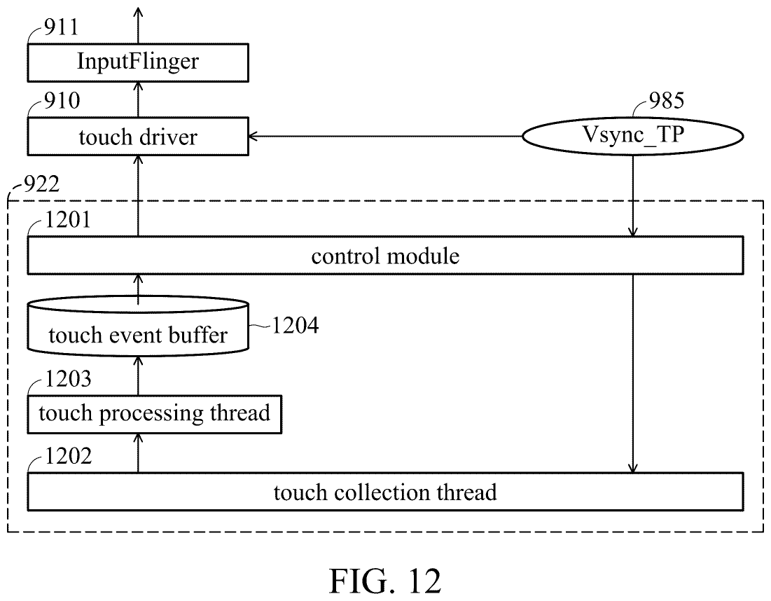

The above-described batch propagation mechanism is implemented in the touch firmware ran by the touch panel. Refer to FIG. 12, which is an architecture diagram of the touch firmware 922 implementing the batch propagation mechanism, according to an embodiment of the present disclosure. As shown in FIG. 12, the touch firmware 922 may include a control module 1201, a touch collection thread 1202, and a touch processing thread 1203. The touch collection thread 1202 is configured to collect a batch of touch events within one cycle of the application synchronization signal. The touch processing thread 1203 is configured to process the touch events collected by the touch collection thread 1202 and store the processed touch events into a touch event buffer 1204. The control module 1201 is configured to handle the batch of touch events. The handling of the batch of touch events is triggered by the expiration of the input synchronization signal (Vsync_TP) 985. More details about the handling of the batch of touch events will be explained in the next paragraph.

Upon the expiration of the input synchronization signal, the control module 1201 triggers the touch collection thread 1202 to collect an immediate touch event. The immediate touch event is then processed by the by the touch processing thread 1203. The processing of the immediate touch event and other touch events may include operations such as parsing, filtering, debouncing, and/or smoothing their content, but the present disclosure is not limited thereto. After being processed, the immediate touch event is stored into the touch event buffer 1204, which may already store other touch events accumulated within one cycle of the application synchronization signal. The touch event buffer 1204 can be implemented using a volatile memory, such as dynamic random-access memory (DRAM) or a static random-access memory (SRAM), but the present disclosure is not limited thereto. The control module 1201 then propagates this batch of touch events stored in the touch event buffer 1204 up to the touch driver 910 ran by the application processor. The touch driver 910 then propagates this batch of touch events up to the application program 912 (not shown in FIG. 12) through the InputFlinger 911.

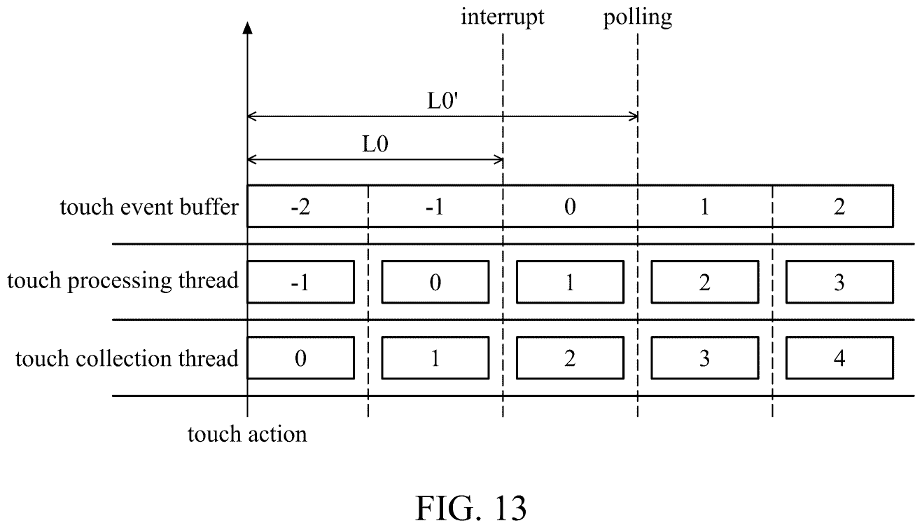

FIG. 13 is a timing diagram of touch event handling in the touch firmware 922, according to an embodiment of the present disclosure. In FIG. 13, the block labeled “0” indicates the touch event currently being collected by the touch collection thread 1202 after the user's touch action. Blocks marked with negative numbers like −1 and −2 indicate past touch events that have already been processed by the corresponding thread and are stored in the touch event buffer 1204, awaiting propagation up to the application processor. Blocks marked with positive numbers like 1, 2, and 3 indicate future touch events that will be collected and processed. If polling is performed according to the input synchronization signal 985, the delay will be longer, and at least three cycles will pass after the touch action is triggered before the touch driver 910 receives the touch events, thereby increasing the touch response delay of the touch events. To further reduce the touch response delay of the touch events, the touch firmware 922 must adopt an immediate sampling technique to handle and propagate the touch events up to the application processor. That is why the aforementioned immediate touch event must be included in the batch of touch events being handled. Upon the expiration of the input synchronization signal 985, the touch collection thread 1202 and the touch processing thread 1203 are triggered. Once completed, the touch events are propagated up through an interrupt, allowing the touch driver 910 to receive the touch event as soon as possible. As shown in FIG. 13, L0 is the delay for the “interrupt” method, L0′ is the delay for the “polling” method, and L0 is shorter than L0′.

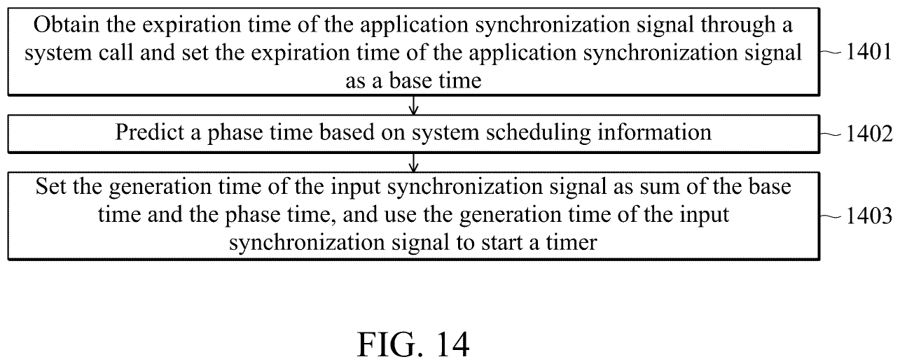

FIG. 14 is a flow diagram illustrating the generation process of the input synchronization signal 985, according to an embodiment of the present disclosure. As shown in FIG. 14, the application processor 91 may generate the input synchronization signal (Vsync_TP) 985 by executing steps 1401-1403.

In step 1401, the application processor 91 obtains the expiration time of the application synchronization signal (Vsync_APP) 980 through a system call, such as “/vsync_app”. Then, the application processor sets the expiration time of the application synchronization signal 980 as a base time.

In step 1402, the application processor 91 predicts a phase time based on system scheduling information. The phase time refers to the time required for the touch driver and InputFlinger to propagate the touch event up to the application program. The system scheduling information may involve CPU load, process priority, and/or scheduling queues, but the present disclosure is not limited thereto.

In an embodiment, the prediction of the phase time is implemented by using a machine learning-based algorithm and a debounce algorithm. Specifically, a trained regression model or neural network can be used to initially predict the phase time based on the system scheduling information. Considering that fluctuations in the phase time value might affect the uniformity of the propagation timing, the predicted phase time should be processed through a debounce algorithm before being updated through a system call such as “/vsync_phase”. However, it should be noted that a machine learning-based algorithm is not the only way to predict the phase time. In other embodiments, theoretical formulas, look-up tables with interpolation, or other specific algorithms can be used to achieve phase time prediction.

In step 1403, the application processor 91 sets the generation time of the input synchronization signal 985 as the sum of the base time and the phase time, and uses the generation time of the input synchronization signal 985 to start a timer. The timer is configured to notify the touch driver 910 to propagate the touch event up to the application program through the InputFlinger, upon the expiration of the input synchronization signal (Vsync_TP).

It should be noted that the phase time dynamically changes with the system scheduling conditions. Therefore, the aforementioned phase time prediction mechanism takes into account the system scheduling information, ensuring that touch events are consumed by the UI thread at the optimal expected timing under different system scenarios, thereby achieving the best system performance.

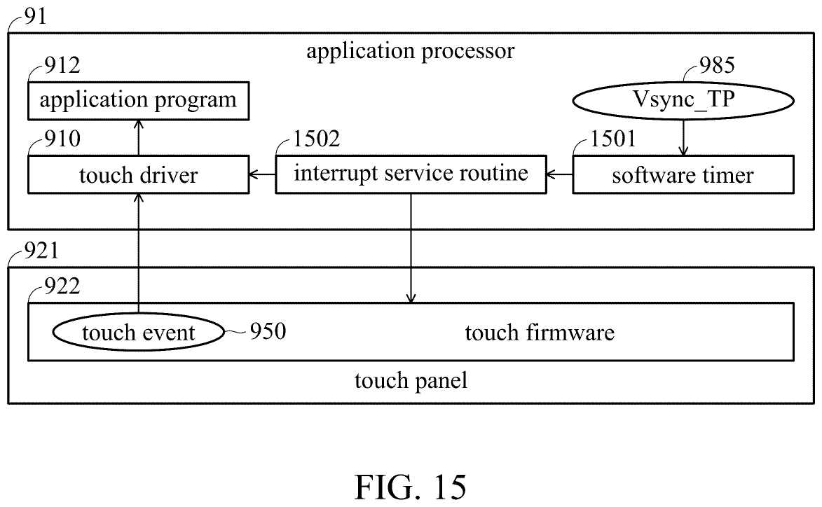

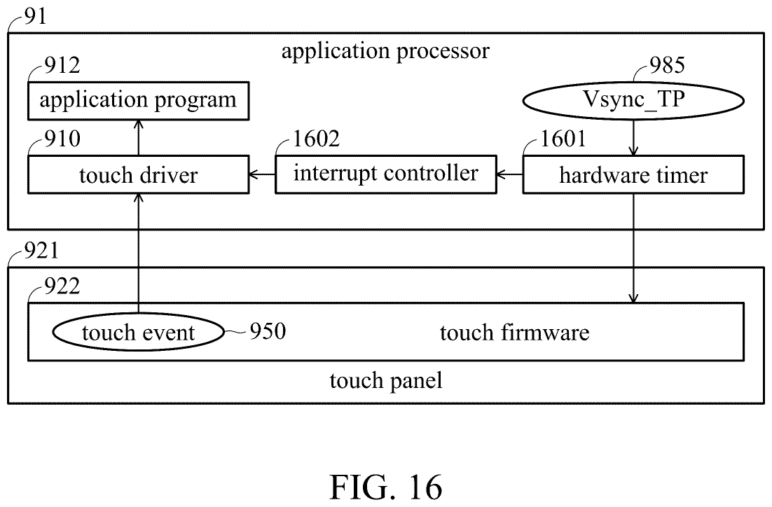

In some embodiments, the application processor 91 is directly connected to the touch panel 921. Therefore, the application processor 91 and the touch panel 921 are communicable with each other through GPIO or other suitable interface protocols. Furthermore, the application processor 91 can directly notice the touch firmware 922 about the expiration of the input synchronization signal 985, so as to trigger the collection and propagation of the touch event 950. Two embodiments of the input synchronization signal expiration notification mechanism in system 90, where the application processor 91 is directly connected to the touch panel 921, will be showcased with reference to FIG. 15 and FIG. 16.

FIG. 15 illustrates the first embodiment of the input synchronization signal expiration notification mechanism adopted in the system for touch input handling. As shown in FIG. 15, besides the application program 912 and the touch driver 910, the application processor 91 further runs a software timer 1501 and an interrupt service routine 1502. Additionally, application processor 91 starts the software timer 1501 according to the input synchronization signal 985. The software timer 1501 is configured to notify the touch firmware 922 through the interrupt service routine 1502 to collect the touch event 950 and propagate the touch event 950 up to the touch driver 910, upon the expiration of the input synchronization signal 985. Also, the software timer 1501 is configured to notify the touch driver 910 through the interrupt service routine 1502 to propagate the touch event 950 up to the application program 912, upon the expiration of the input synchronization signal 985.

FIG. 16 illustrates the second embodiment of the input synchronization signal expiration notification mechanism adopted in the system for touch input handling. As shown in FIG. 16, the application processor 91 further includes a hardware timer 1601 and an interrupt controller 1602. The application processor 91 starts the hardware timer 1601 according to the input synchronization signal 985. The hardware timer 1601 is configured to notify the touch firmware 922 to collect the touch event 950 and propagate the touch event 950 up to the touch driver 910, upon the expiration of the input synchronization signal 985. Also, the hardware timer 1601 is further configured to notify the touch driver 910 through the interrupt controller 1602 to propagate the touch event 950 up to the application program 912, upon the expiration of the input synchronization signal 985.

The comparison of the two embodiments illustrated in FIG. 15 and FIG. 16 is presented below. In the first embodiment, the software handles the timing of the input synchronization signal 985 and notifies the touch firmware 922 through software-controlled GPIO, exempting from the need for additional hardware components. However, both the software timer 1501 and the interrupt service routine 1502 consume system computational resources and may degrade signal transmission efficiency under heavy system load. In contrast, the second embodiment directly utilizes interrupts to notify both the touch firmware 922 and touch driver 910, thereby enhancing system stability and improves signal transmission efficiency.

In some embodiments, the touch event 950 is not directly propagated from the touch panel 921 to the application processor 91. Instead, it passes through a microprocessor. This approach is based on the consideration that a microprocessor consumes less power to receive touch event data from the touch panel 921 compared to the application processor 91. Thus, utilizing a microprocessor to facilitate the propagation of the touch event 950 can further reduce system power consumption.

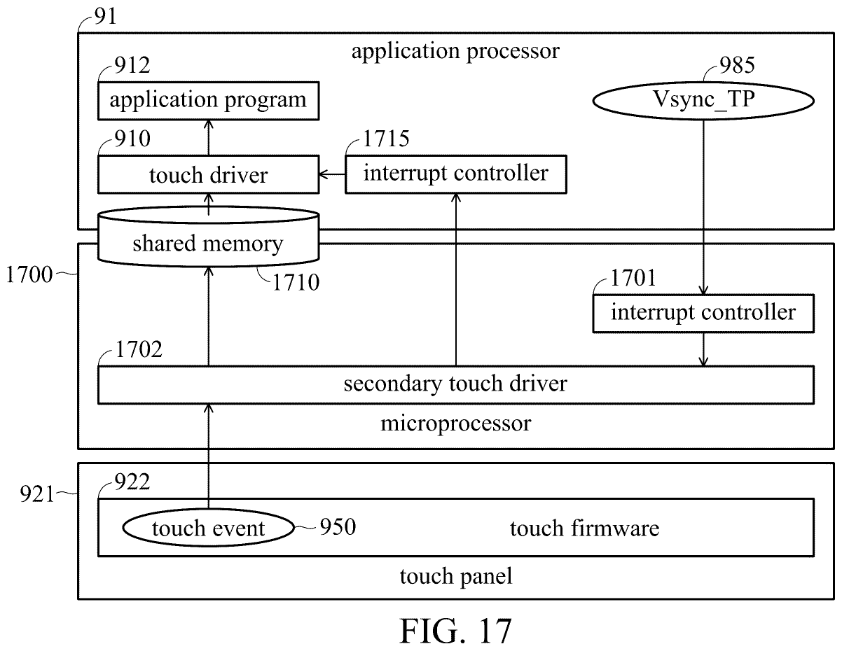

FIG. 17 illustrates the third embodiment of the system for touch input handling, in which a microprocessor 1700 is included in the system to facilitate the propagation of the touch event 950. In the third embodiment, the microprocessor 1700 is directly connected to the touch panel 921 and the application processor 91. Therefore, the microprocessor 1700 is communicable with the touch panel 921 and the application processor 91 through GPIO or other suitable interface protocols. The microprocessor 1700 includes an interrupt controller 1701, and runs a secondary touch driver 1702. In addition, the system further includes a shared memory 1710 that is accessible by both the microprocessor 1700 and the application processor 91. The shared memory 1710 can be implemented using a volatile memory, such as dynamic random-access memory (DRAM) or a static random-access memory (SRAM), but the present disclosure is not limited thereto. The application processor 91 further includes an interrupt controller 1715. More details about the additional elements in FIG. 17 and their interactions will be explained in the next paragraph.

In the third embodiment, the expiration of the input synchronization signal 985 triggers the interrupt controller 1701 to send an interrupt request signal to the secondary touch driver 1702. The secondary touch driver 1702 is configured to handle the touch event 950 upon receiving the interrupt request signal. For the secondary touch driver 1702, the handling of the touch event includes receiving the touch event 950 propagated from the touch firmware 922, storing the touch event 950 into the shared memory 1710, and notifying the touch driver 910 through the interrupt controller 1715 to read the touch event 950 from the shared memory 1710. Upon receiving the notice from the secondary touch driver 1702, the touch driver 910 reads the touch event 950 from the shared memory 1710 and propagates the touch event 950 up to the application program 912. The subsequent process of image drawing, rendering, composing, and displaying is as illustrated in FIG. 9, and will not be reiterated herein.

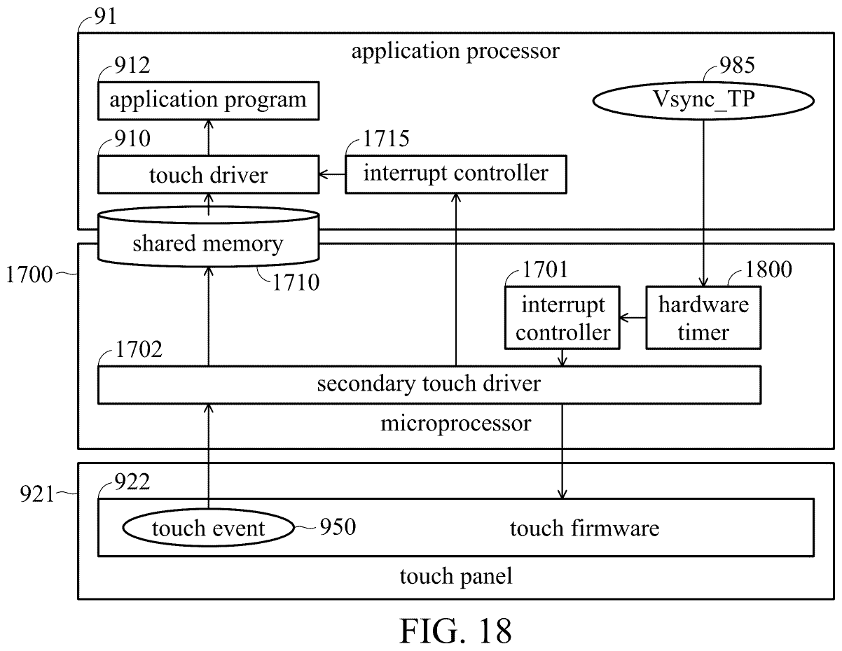

Different input synchronization signal expiration notification mechanisms can bring diverse implementations to the third embodiment. Specifically, the input synchronization signal expiration notification mechanisms involves the use of a hardware timer to notify the secondary touch driver 1702 that the input synchronization signal 985 expires, triggering the secondary touch driver 1702 to handle the touch event 950. This hardware timer can be deployed either in application processor 91 or the microprocessor 1700. Furthermore, either the hardware timer or the secondary touch driver 1702 can be used to notify the touch firmware 922 that the input synchronization signal 985 expires, triggering the touch firmware 922 to collect and propagate touch event 950. Accordingly, four implementations of the third embodiment will be showcased with reference to FIGS. 18-21.

FIG. 18 illustrates the first implementation of the third embodiment of the system for touch input handling, in which the microprocessor 1700 is included in the system to facilitate the propagation of the touch event 950. In the first implementation, a hardware timer 1800 is included in the microprocessor 1700. The microprocessor 1700 starts the hardware timer 1800 according to the input synchronization signal 985. The hardware timer 1800 is configured to notify the secondary touch driver 1702 through the interrupt controller 1701 to handle the touch event 950, upon the expiration of the input synchronization signal 985. For the secondary touch driver 1702, the handling of the touch event is as previously described with reference to FIG. 17, and will not be reiterated herein. On the other hand, the secondary touch driver 1702 is further configured to notify the touch firmware 922 to collect the touch event 950 and propagate the touch event 950 up to the secondary touch driver 1702, upon receiving the interrupt request signal from the interrupt controller 1701.

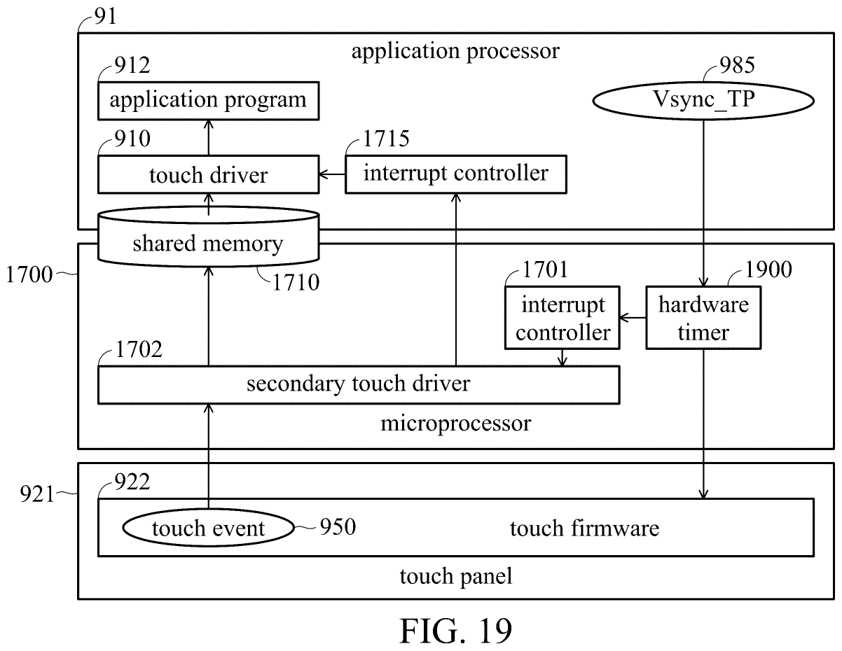

FIG. 19 illustrates the second implementation of the third embodiment of the system for touch input handling, in which the microprocessor 1700 is included in the system to facilitate the propagation of the touch event 950. In the second implementation, a hardware timer 1900 is included in the microprocessor 1700. In addition, the hardware timer 1900 is directly connected to the touch panel 921, so that the hardware timer 1900 is communicable with the touch panel 921 through GPIO or other suitable interface protocols. The microprocessor 1700 starts the hardware timer 1900 according to the input synchronization signal 985. The hardware timer 1900 is configured to notify the secondary touch driver 1702 through the interrupt controller 1701 to handle the touch event 950, upon the expiration of the input synchronization signal 985. For the secondary touch driver 1702, the handling of the touch event is as previously described with reference to FIG. 17, and will not be reiterated herein. On the other hand, the hardware timer 1900 is further configured to notify the touch firmware 922 to collect the touch event 950 and propagate the touch event 950 up to the secondary touch driver 1702, upon the expiration of the input synchronization signal 985.

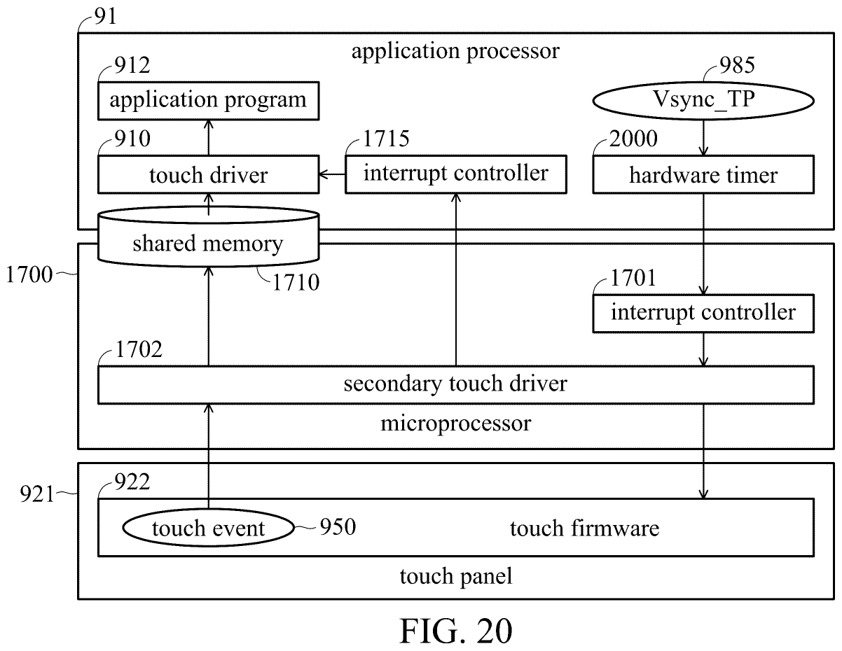

FIG. 20 illustrates the third implementation of the third embodiment of the system for touch input handling, in which the microprocessor 1700 is included in the system to facilitate the propagation of the touch event 950. In the third implementation, a hardware timer 2000 is included in the application processor 91. In addition, the hardware timer 2000 is directly connected to the interrupt controller 1701, so that the hardware timer 2000 is communicable with the interrupt controller 1701 through GPIO or other suitable interface protocols. The application processor 91 starts the hardware timer 2000 according to the input synchronization signal 985. The hardware timer 2000 is configured to notify the secondary touch driver 1702 through the interrupt controller 1701 to handle the touch event 950, upon the expiration of the input synchronization signal 985. For the secondary touch driver 1702, the handling of the touch event is as previously described with reference to FIG. 17, and will not be reiterated herein. On the other hand, the secondary touch driver 1702 is further configured to notify the touch firmware 922 to collect the touch event 950 and propagate the touch event 950 up to the secondary touch driver 1702, upon receiving the interrupt request signal from the interrupt controller 1701.

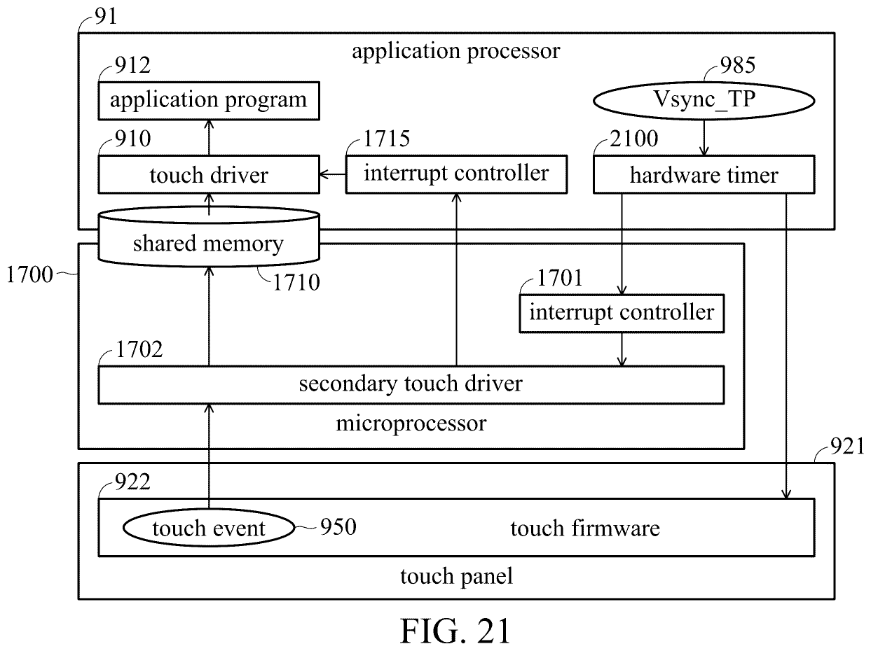

FIG. 21 illustrates the fourth implementation of the third embodiment of the system for touch input handling, in which the microprocessor 1700 is included in the system to facilitate the propagation of the touch event 950. In the fourth implementation, a hardware timer 2100 is included in the application processor 91. In addition, the hardware timer 2100 is directly connected to both the interrupt controller 1701 and the touch panel 921, so that the hardware timer 2100 is communicable with both the interrupt controller 1701 and the touch panel 921 through GPIO or other suitable interface protocols. The application processor 91 starts the hardware timer 2100 according to the input synchronization signal 985. The hardware timer 2100 is configured to notify the secondary touch driver 1702 through the interrupt controller 1701 to handle the touch event 950, upon the expiration of the input synchronization signal 985. For the secondary touch driver 1702, the handling of the touch event is as previously described with reference to FIG. 17, and will not be reiterated herein. On the other hand, the hardware timer 2100 is further configured to notify the touch firmware 922 to collect the touch event 950 and propagate the touch event 950 up to the secondary touch driver 1702, upon the expiration of the input synchronization signal 985.

The comparison of the four implementations illustrated in FIGS. 18-21 is presented below. In the schemes where the hardware timer is deployed in the microprocessor 1700 (i.e., the first implementation illustrated in FIG. 18 and the second implementation illustrated in FIG. 19), the application processor 91 needs to send a system message to the microprocessor 1700 to start the hardware timer when the input synchronization signal 985 expires. This somewhat extends the notification path and the overall system touch response delay. In contrast, in the schemes where the hardware timer is deployed in the application processor 91 (i.e., the third implementation illustrated in FIG. 20 and the fourth implementation illustrated in FIG. 21), the hardware timer can directly communicate with the interrupt controller 1701 through GPIO or other suitable interface protocols, resulting in a shorter notification path and overall system touch response delay. Therefore, the third implementation is better than the first implementation, and the fourth implementation is better than the second implementation.

On the other hand, in the schemes where the hardware timer is directly connected to the touch panel 921 (i.e., the second implementation illustrated in FIG. 19 and the fourth implementation illustrated in FIG. 21), the hardware timer can directly notify the touch firmware 922 through GPIO or other suitable interface protocols about the expiration of the input synchronization signal 985 to trigger the collection and propagation of the touch event 950. This is more efficient and stable compared to the other two schemes (i.e., the first implementation illustrated in FIG. 18 and the third implementation illustrated in FIG. 20), which require the secondary touch driver 1702 to notify the touch firmware 922 through software-controlled GPIO. Therefore, the second implementation is better than the first implementation, and the fourth implementation is better than the third implementation. Among these four implementations, the fourth implementation is the optimal one of the third embodiment.

Additionally, it is worth mentioning that, in systems that include a microprocessor, a software timer can be configured at the application processor layer to handle signal timing and expiration notifications. Using software-controlled GPIO for notifications can exempt the need for additional hardware components. However, the software timer consumes system computational resources, making its signal transmission performance less efficient compared to the hardware timer solution.

The Android-based system for touch input handling provided by the embodiments of the present disclosure can satisfy user requirements for touch response and standby time of touch terminals while maintaining both high sampling rates and low power consumption.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An Android-based system for touch input handling, comprising:
an interactive hardware, comprising a display panel and a touch panel that runs a touch firmware; and
an application processor, coupled to the interactive hardware, and running an application program and a touch driver;
wherein the application processor further converts a hardware synchronization signal of the display panel into a software synchronization signal, and generates an application synchronization signal based on the software synchronization signal;
wherein expiration of the application synchronization signal triggers a UI thread of the application program to draw one or more image layers in response to a touch event collected by the touch panel;
wherein the application processor further generates an input synchronization signal that is synchronized with the application synchronization signal; and
wherein expiration of the input synchronization signal triggers the touch firmware to collect the touch event and propagate the touch event up to the application program through the touch driver.

2. The system as claimed in claim 1, wherein the touch firmware comprises:
a touch collection thread, configured to collect a batch of touch events within one cycle of the application synchronization signal;
a touch processing thread, configured to process the touch events collected by the touch collection thread and store the processed touch events into a touch event buffer; and
a control module, configured to handle the batch of touch events, wherein handling the batch of touch events is triggered by the expiration of the input synchronization signal, and includes triggering the touch collection thread and the touch processing thread to collect, process, and store an immediate touch event, and propagating up the batch of touch events, including the immediate touch event, from the touch event buffer to the touch driver.

3. The system as claimed in claim 1, wherein the application processor generates the input synchronization signal by executing steps as follows:
obtaining expiration time of the application synchronization signal through a system call and setting the expiration time of the application synchronization signal as a base time;
predicting a phase time based on system scheduling information, wherein the phase time refers to time required for the touch driver and InputFlinger to propagate the touch event up to the application program; and
setting a generation time of the input synchronization signal as sum of the base time and the phase time, and using the generation time of the input synchronization signal to start a timer;
wherein the timer is configured to notify the touch driver to propagate the touch event up to the application program through the InputFlinger, upon the expiration of the input synchronization signal.

4. The system as claimed in claim 3, wherein the application processor predicts the phase time by using a machine learning-based algorithm and a debounce algorithm.

5. The system as claimed in claim 1, wherein the application processor is directly connected to the touch panel.

6. The system as claimed in claim 5, wherein the application processor further runs a software timer and an interrupt service routine, and starts the software timer according to the input synchronization signal;
wherein the software timer is configured to notify the touch firmware through the interrupt service routine to collect the touch event and propagate the touch event up to the touch driver, upon the expiration of the input synchronization signal; and
wherein the software timer is further configured to notify the touch driver through the interrupt service routine to propagate the touch event up to the application program, upon the expiration of the input synchronization signal.

7. The system as claimed in claim 5, wherein the application processor further comprises a hardware timer and an interrupt controller, and starts the hardware timer according to the input synchronization signal;
wherein the hardware timer is configured to notify the touch firmware to collect the touch event and propagate the touch event up to the touch driver, upon the expiration of the input synchronization signal; and
wherein the hardware timer is further configured to notify the touch driver through the interrupt controller to propagate the touch event up to the application program, upon the expiration of the input synchronization signal.

8. The system as claimed in claim 1, further comprising:
a microprocessor, directly connected to the touch panel and the application processor, comprising a first interrupt controller, and running a secondary touch driver, wherein the expiration of the input synchronization signal triggers the first interrupt controller to send an interrupt request signal to the secondary touch driver; and
a shared memory, accessible by both the microprocessor and the application processor;
wherein the application processor further comprises a second interrupt controller;
wherein the secondary touch driver is configured to handle the touch event upon receiving the interrupt request signal, and wherein handling the touch event includes receiving the touch event propagated from the touch firmware, storing the touch event into the shared memory, and notifying the touch driver through the second interrupt controller to read the touch event from the shared memory.

9. The system as claimed in claim 8, wherein the microprocessor further comprises a hardware timer, and starts the hardware timer according to the input synchronization signal;
wherein the hardware timer is configured to notify the secondary touch driver through the first interrupt controller to handle the touch event, upon the expiration of the input synchronization signal.

10. The system as claimed in claim 9, wherein the secondary touch driver is further configured to notify the touch firmware to collect the touch event and propagate the touch event up to the secondary touch driver, upon receiving the interrupt request signal.

11. The system as claimed in claim 9, wherein the hardware timer is directly connected to the touch panel, and is further configured to notify the touch firmware to collect the touch event and propagate the touch event up to the secondary touch driver, upon the expiration of the input synchronization signal.

12. The system as claimed in claim 8, wherein the application processor further comprises a hardware timer that is directly connected to the first interrupt controller, and starts the hardware timer according to the input synchronization signal;
wherein the hardware timer is configured to notify the secondary touch driver through the first interrupt controller to handle the touch event, upon the expiration of the input synchronization signal.

13. The system as claimed in claim 12, wherein the secondary touch driver is further configured to notify the touch firmware to collect the touch event and propagate the touch event up to the secondary touch driver, upon receiving the interrupt request signal.

14. The system as claimed in claim 12, wherein the hardware timer is directly connected to the touch panel, and is further configured to notify the touch firmware to collect the touch event and propagate the touch event up to the secondary touch driver, upon the expiration of the input synchronization signal.

15. The system as claimed in claim 1, wherein the application processor further generates a SurfaceFlinger synchronization signal based on the software synchronization signal;
wherein a render thread of the application program is configured to render the image layers drawn by the UI thread;
wherein the application processor further runs a SurfaceFlinger thread that is triggered by expiration of the SurfaceFlinger synchronization signal to compose the image layers rendered by the render thread into an output image for display on the display panel.
